(19) United States
(12) Patent Application Publication
(10) Pub. No.: US 2020/0024467 A1
(43) Pub. Date: Jan. 23, 2020

(54) INKJET RECORDING INK

(71) Applicant: KYOCERA Document Solutions Inc., Osaka (JP)

(72) Inventor: Jun HIOKI, Osaka-shi (JP)

(73) Assignee: KYOCERA Document Solutions Inc., Osaka (JP)

(21) Appl. No.: 16/506,599

(22) Filed: Jul. 9, 2019

(30) Foreign Application Priority Data
Jul. 23, 2018 (JP) 2018-137691

(51) Int. Cl. C09D 11/326; C09D 11/38

(52) U.S. Cl. CPC C09D 11/326; C09D 11/38

(57) ABSTRACT

An inkjet recording ink contains an aqueous medium, a pigment, binder resin particles, and hydrophilic inorganic particles. A content rate of the binder resin particles is at least 4.0% by mass and no greater than 20.0% by mass. A content rate of the hydrophilic inorganic particles is at least 1.0% by mass and no greater than 12.0% by mass. The inkjet recording ink does not contain an organic solvent having a boiling point of at least 150° C., or contains an organic solvent having a boiling point of at least 150° C. in a content rate over 0.0% by mass and no greater than 4.0% by mass.

### INCORPORATION BY REFERENCE

The present application claims priority under 35 U.S.C. § 119 to Japanese Patent Application No. 2018-137691, filed on Jul. 23, 2018. The contents of this application are incorporated herein by reference in their entirety.

### BACKGROUND

The present disclosure relates to an inkjet recording ink.

As an example of an inkjet recording ink, for example, an inkjet recording ink containing a pigment, resin particles, an organic solvent having a high boiling point (such as glycerin), and water has been proposed.

### SUMMARY

An inkjet recording ink according to the present disclosure contains an aqueous medium, a pigment, binder resin particles, and hydrophilic inorganic particles. A content rate of the binder resin particles is at least 4.0% by mass and no greater than 20.0% by mass. A content rate of the hydrophilic inorganic particles is at least 1.0% by mass and no greater than 12.0% by mass. The inkjet recording ink does not contain an organic solvent having a boiling point of at least 150° C., or contains an organic solvent having a boiling point of at least 150° C. in a content rate over 0.0% by mass and no greater than 4.0% by mass.

### DETAILED DESCRIPTION

Now, an embodiment of the present disclosure will be described in detail.

The present disclosure is, however, not limited to the following embodiment at all. The present disclosure can be practiced with appropriate alteration made within the scope of the object of the present disclosure. Although explanation is omitted as appropriate, such omission does not limit the essence of the present invention. In regard to each component described below, one type of the component may be singly used, or two or more types may be used in combination unless otherwise stated.

In the embodiment of the present disclosure, an evaluation result (a value corresponding to a shape, a physical property or the like) regarding particles is a number average of measured values of a considerable number of particles unless otherwise stated. Besides, in the embodiment of the present disclosure, the term “-based” is appended, in some cases, to the name of a chemical compound to be used as a generic name encompassing both the chemical compound and derivatives thereof. When the term “-based” is appended to the name of a chemical compound used in the name of a polymer, the term indicates that a repeating unit of the polymer originates from the chemical compound or a derivative thereof. Furthermore, in the embodiment of the present disclosure, the term “(meth)acryl” may be used as a generic term encompassing both acryl and methacryl.

In the embodiment of the present disclosure, a volume average particle diameter (MV) of particles is a secondary particle diameter measured using a particle size distribution analyzer employing a dynamic light scattering method (such as “ZETA SIZER (registered Japanese trademark) NANO ZS” manufactured by Symex Corporation) unless otherwise stated.

<Inkjet Recording Ink>

An inkjet recording ink (hereinafter sometimes referred to as an ink) according to an embodiment of the present disclosure contains an aqueous medium, a pigment, binder resin particles, and hydrophilic inorganic particles. In the ink of the present embodiment, a content rate of the binder resin particles is at least 4.0% by mass and no greater than 20.0% by mass. In the ink of the present embodiment, a content rate of the hydrophilic inorganic particles is at least 1.0% by mass and no greater than 12.0% by mass. The ink of the present embodiment does not contain an organic solvent having a boiling point of at least 150° C., or contains an organic solvent having a boiling point of at least 150° C. in a content rate over 0.0% by mass and no greater than 4.0% by mass. The ink of the present embodiment preferably further contains a surfactant.

The ink of the present embodiment may be used, for example, in a method for forming an image on a recording medium using an inkjet recording device. Specifically, when the ink of the present embodiment is ejected onto a recording medium from a recording head of an inkjet recording device, an image can be formed on the recording medium. As a method for ejecting the ink of the present embodiment through a recording head, for example, a thermal method, a piezo method, a continuous method, or a bubble method can be employed.

Examples of the recording medium on which an image is formed with the ink of the present embodiment include recording media of, for example, paper, a resin, a metal, glass, and ceramics. Specific examples of the recording medium include general copy paper (plain paper in particular), recycled paper, thin paper, cardboard, glossy paper, coated paper, a resin film, and an OHP sheet. Another example of the recording medium includes a recording medium processed with fiber (such as a fabric). In other words, the ink of the present embodiment can be used also in inkjet textile printing.

The ink of the present embodiment can be used to form an image with excellent durability, and is excellent in ejection stability. The ink of the present embodiment is suitably used for forming an image on a recording medium having low permeability, such as coated paper, or a resin film (such as a packaging film for food or the like). The reason is presumed as follows. Since the ink of the present embodiment contains a prescribed amount of the binder resin particles, even when a recording medium having low permeability is used, the pigment can be easily fixed on a surface of the recording medium. Besides, the ink of the present embodiment does not contain an organic solvent having a boiling point of at least 150° C., or contains an organic solvent having a boiling point of at least 150° C. in a content rate over 0.0% by mass and no greater than 4.0% by mass. Here, a high-boiling point organic solvent is generally added to a known ink for purposes of adjusting viscosity and surface tension. A high-boiling point organic solvent is, however, difficult to evaporate as compared with water, and hence tends to remain in an image formed with the ink to degrade its durability. This tendency is conspicuous particularly when an image is formed on a recording medium having low permeability. By contrast, since the ink of the present embodiment does not contain a high-boiling point organic solvent or contains a high-boiling point organic solvent in a prescribed or lower rate, the high-boiling point organic solvent can be inhibited from remaining in a formed image, resulting in improving durability of the image. Besides, the ink of the present embodiment does not contain a high-boiling point organic solvent or contains a high-boiling point organic solvent in a prescribed or lower rate, but contains the hydrophilic inorganic particles instead in a prescribed rate, and therefore, viscosity and surface tension required of the ink can be ensured, and hence the ejection stability is excellent.

The viscosity of the ink at 25° C. is preferably at least 4 mPa·s and no greater than 8 mPa·s. Besides, the surface tension of the ink at 25° C. is preferably at least 25 mN/m and no greater than 35 mN/m. When the viscosity and the surface tension of the ink at 25° C. respectively fall in the aforementioned ranges, ejection stability can be further improved. The viscosity and the surface tension of the ink can be adjusted by, for example, increasing or decreasing the content rate of the hydrophilic inorganic particles.

Incidentally, the viscosity of the ink is measured using a falling ball viscometer. As the falling ball viscometer, for example, a falling ball automated microviscometer (“AMVn” manufactured by Anton Paar GmbH) can be used. The surface tension of the ink is measured, for example, in accordance with a Wilhelmy method (plate method). As a surface tensiometer, for example, “AUTOMATED SURFACE TENSIOMETER DY-300” manufactured by Kyowa Interface Science, Inc. can be used.

[Aqueous Medium]

The aqueous medium is a medium mainly containing water, and may contain a different solvent if necessary. The different solvent is not especially limited as long as it is water-soluble, and is, for example, an organic solvent. A content rate of water in the aqueous medium is preferably at least 60% by mass, more preferably at least 80% by mass, further preferably at least 95% by mass, and particularly preferably 100% by mass.

A content rate of water in the ink is preferably at least 40.0% by mass and no greater than 90.0% by mass, and more preferably at least 60.0% by mass and no greater than 85.0% by mass.

(High-Boiling Point Organic Solvent)

The ink does not contain a high-boiling point organic solvent, or contains a high-boiling point organic solvent in a content rate over 0.0% by mass and no greater than 4.0% by mass. As described above, the ink does not contain a high-boiling point organic solvent, or even when the ink contains a high-boiling point organic solvent, the content rate of the high-boiling point organic solvent in the ink is over 0.0% by mass and no greater than 4.0% by mass. Therefore, durability of a formed image can be improved. It is preferable that the ink does not contain a high-boiling point organic solvent, or contains a high-boiling point organic solvent in a content rate of over 0.0% by mass and no greater than 0.5% by mass. It is particularly preferable that the ink does not contain a high-boiling point organic solvent. Note that, when the ink contains at least two high-boiling point organic solvents, the content rate of the high-boiling point organic solvent mentioned above means a total content rate of the at least two high-boiling point organic solvents.

Examples of the high-boiling point organic solvent include polyhydric alcohol compounds and polyhydric alcohol ether compounds having a boiling point of at least 150° C. Examples of the polyhydric alcohol compounds include glycerin, ethylene glycol, diethylene glycol, triethylene glycol, propylene glycol, dipropylene glycol, hexylene glycol, 1,4-butanediol, 1,5-pentanediol, 1,2,4-butanetriol, and 2,2′-thiodiethanol. Examples of the polyhydric alcohol ether compounds having a boiling point of at least 150° C. include ethylene glycol monobutyl ether, diethylene glycol monomethyl ether, diethylene glycol monoethyl ether, diethylene glycol monobutyl ether, dipropylene glycol monomethyl ether, dipropylene glycol monoethyl ether, triethylene glycol monomethyl ether, triethylene glycol monobutyl ether, tripropylene glycol monomethyl ether, polyethylene glycol, and polypropylene glycol.

The ink may contain an organic solvent having a boiling point lower than 150° C. (hereinafter sometimes referred to as a low-boiling point organic solvent). When the ink contains the low-boiling point organic solvent, a content rate, in the ink, of the low-boiling point organic solvent is not especially limited, and can be, for example, over 0% by mass and no greater than 10% by mass. Examples of such a low-boiling point organic solvent include a lower alcohol having a carbon number of at least 1 and no greater than 4, an ether compound having a boiling point lower than 150° C., and polyhydric alcohol ether compound having a boiling point lower than 150° C. (such as ethylene glycol monomethyl ether or ethylene glycol monoethyl ether).

[Pigment]

Examples of the pigment include a yellow pigment, an orange pigment, a red pigment, a blue pigment, a violet pigment, and a black pigment. An example of the yellow pigment is C.I. Pigment Yellow (74, 93, 95, 109, 110, 120, 128, 138, 139, 151, 154, 155, 173, 180, 185, or 193). An example of the orange pigment includes C.I. Pigment Orange (34, 36, 43, 61, 63, or 71). An example of the red pigment is C.I. Pigment Red (122 or 202). An example of the blue pigment is C.I. Pigment Blue (15 or 15:3). An example of the violet pigment is C.I. Pigment Violet (19, 23, or 33). An example of the black pigment includes C.I. Pigment Black 7.

A content of the pigment in the ink is preferably at least 1.0% by mass and no greater than 8.0% by mass, and more preferably at least 4.0% by mass and no greater than 6.0% by mass. When the content rate of the pigment is at least 1.0% by mass, a desired image density can be easily obtained. By contrast, when the content rate of the pigment is no greater than 8.0% by mass, flowability of the pigment in the ink is improved, and a desired image density can be easily obtained. Besides, when a permeable recording medium is used, permeability of the ink into the recording medium can be improved by setting the content rate of the pigment to be no greater than 8.0% by mass.

In the ink, the pigment is dispersed in the aqueous medium in the form of particles (hereinafter sometimes referred to as the pigment particles). The pigment particles may contain the pigment alone. Alternatively, the pigment particles may contain the pigment and resin particles coating the surface of the pigment (hereinafter sometimes referred to as the coating resin particles).

When the coating resin particles coat the surface of the pigment, dispersibility of the pigment is improved. A resin contained in the coating resin particles is not especially limited, and examples thereof include a (meth)acrylic resin, a styrene-(meth)acrylic resin, a styrene-maleic acid copolymer, a vinyl naphthalene-(meth)acrylic acid copolymer, and a vinyl naphthalene-maleic acid copolymer. The (meth)acrylic resin is a resin including a repeating unit derived from at least one monomer selected from (meth)acrylic acids and (meth)acrylates. The styrene-(meth)acrylic resin is a resin including a repeating unit derived from styrene, and a repeating unit derived from at least one monomer selected from (meth)acrylic acids and (meth)acrylates. Examples of the styrene-(meth)acrylic resin include a styrene-acrylic acid-acrylic acid alkyl ester copolymer, a styrene-methacrylic acid-methacrylic acid alkyl ester-acrylic acid alkyl ester copolymer, a styrene-acrylic acid copolymer, a styrene-maleic acid-acrylic acid alkyl ester copolymer, a styrene-methacrylic acid copolymer, and a styrene-methacrylic acid alkyl ester copolymer.

When the ink contains the coating resin particles, a content of the coating resin particles in the ink is preferably at least 15 parts by mass and no greater than 100 parts by mass relative to 100 parts by mass of the pigment.

From the viewpoint of improving color density, hue, and stability of the ink, a volume median diameter (D₅₀) of the pigment particles is preferably at least 30 nm and no greater than 200 nm, and more preferably at least 70 nm and no greater than 130 nm.

[Binder Resin Particles]

The binder resin particles are present in a state dispersed in the aqueous medium. The binder resin particles function as a binder in an image formed with the ink, and improves fixability of the pigment on the recording medium.

Examples of a resin contained in the binder resin particles include a urethane resin, a (meth)acrylic resin, a styrene-(meth)acrylic resin, a styrene-maleic acid copolymer, a vinyl naphthalene-(meth)acrylic acid copolymer, and a vinyl naphthalene-maleic acid copolymer. The resin contained in the binder resin particles is preferably a urethane resin or a (meth)acrylic resin. A content rate of the urethane resin or the (meth)acrylic resin in the binder resin particles is preferably at least 80% by mass, and more preferably 100% by mass.

A volume average particle diameter (MV) of the binder resin particles is preferably at least 10 nm and no greater than 500 nm, and more preferably at least 10 nm and no greater than 100 nm.

A content rate of the binder resin particles in the ink is at least 4.0% by mass and no greater than 20.0% by mass, and preferably at least 5.0% by mass and no greater than 10.0% by mass. When the content rate of the binder resin particles is at least 4.0% by mass, the fixability of the pigment on the recording medium can be improved. By contrast, when the content rate of the binder resin particles is no greater than 20.0% by mass, ejection stability of the ink can be improved.

[Hydrophilic Inorganic Particles]

The hydrophilic inorganic particles impart appropriate viscosity and surface tension to the ink to improve ejection stability. Here, the hydrophilic inorganic particles mean inorganic particles having surfaces not subjected to a hydrophobization treatment. The hydrophilic inorganic particles are excellent in dispersibility in an aqueous medium as compared with hydrophobic inorganic particles having surfaces subjected to a hydrophobization treatment.

Examples of the hydrophilic inorganic particles include hydrophilic silica particles, aluminum oxide particles, titanium oxide particles, zinc oxide particles, and layered silicate particles. The hydrophilic inorganic particles are preferably hydrophilic silica particles. When the hydrophilic silica particles are used as the hydrophilic inorganic particles, influence on color tone of the ink can be reduced. Besides, since the hydrophilic silica particles have a comparatively low specific gravity, they are difficult to settle in the ink when used as the hydrophilic inorganic particles.

Examples of the hydrophilic silica particles include hydrophilic fumed silica particles, hydrophilic colloidal silica particles, and hydrophilic crushed silica particles, among which hydrophilic fumed silica particles or hydrophilic colloidal silica particles are preferred.

A volume average particle diameter (MV) of the hydrophilic inorganic particles is preferably at least 50 nm and no greater than 300 nm, and more preferably at least 80 nm and no greater than 200 nm.

A content rate of the hydrophilic inorganic particles in the ink is at least 1.0% by mass and no greater than 12.0% by mass, and preferably at least 5.0% by mass and no greater than 9.0% by mass. When the content rate of the hydrophilic inorganic particles is at least 1.0% by mass and no greater than 12.0% by mass, viscosity of the ink can be appropriately increased with ejection stability and storage stability of the ink maintained.

[Surfactant]

The surfactant improves wettability of the ink on the surface of the recording medium. Therefore, when a permeable recording medium is used, permeability of the ink into the recording medium is improved. Examples of the surfactant include an anionic surfactant, a cationic surfactant, an amphoteric surfactant, and a nonionic surfactant, among which a nonionic surfactant is preferred. The nonionic surfactant is preferably an acetylene glycol surfactant or a polysiloxane surfactant.

The acetylene glycol surfactant is preferably 2,4,7,9-tetramethyl-5-decin-4,7-diol, 3,6-dimethyl-4-octin-3,6-diol, 3,5-dimethyl-1-hexin-3-ol, or 2,4-dimethyl-5-hexin-3-ol. Examples of a commercially available acetylene glycol surfactant include “OLFINE (registered Japanese trademark) E1010”, “OLFINE (registered Japanese trademark) STG”, “OLFINE (registered Japanese trademark) Y”, “SURFYNOL (registered Japanese trademark) 82”, “SURFYNOL (registered Japanese trademark) 104”, “SURFYNOL (registered Japanese trademark) 465”, “SURFYNOL (registered Japanese trademark) 485”, and “SURFYNOL (registered Japanese trademark) TG” manufactured by Nissin Chemical Co., Ltd.

When the ink contains the surfactant, the content rate is preferably at least 0.05% by mass and no greater than 5.00% by mass, and more preferably at least 0.1% by mass and no greater than 2.0% by mass.

[Additional Additive]

The ink may further contain an additional additive in addition to the above-described components. Examples of the additional additive include a pH adjusting agent, a fixer, an antifungal agent, a preservative, an antioxidant, a UV absorber, a chelating agent, and an oxygen absorber. An example of the pH adjusting agent is tertiary amine (more specifically, triethanolamine). An example of the fixer is water-soluble rosin. An example of the antifungal agent is sodium benzoate. It is noted that sodium benzoate also has a function as a preservative. An example of the antioxidant is an allophanate.

[Method for Producing Ink]

A method for producing the ink is not especially limited, and for example, a method can be employed in which a pigment dispersion, a binder resin particle dispersion, a hydrophilic inorganic particle dispersion, and an optional component such as a surfactant used if necessary are mixed, and the resultant is diluted with an aqueous medium (such as water) if necessary. Here, the pigment dispersion refers to a dispersion containing an aqueous medium, and pigment particles dispersed in the aqueous medium. The binder resin particle dispersion refers to a dispersion containing an aqueous medium and binder resin particles dispersed in the aqueous medium. The hydrophilic inorganic particle dispersion refers to a dispersion containing an aqueous medium and hydrophilic inorganic particles dispersed in the aqueous medium. Note that when water is used in producing the ink, ion exchanged water or pure water is preferably used.

When a commercially available product is used as the hydrophilic inorganic particle dispersion, the commercially available product may be directly used, or may be subjected to a high pressure dispersion treatment (for example, under a condition of a pressure of at least 30 MPa and no greater than 80 MPa) before use.

### EXAMPLES

The present disclosure will now be more specifically described by way of examples. It is noted that the present disclosure is not, however, limited to the scope of the examples. First, methods for measuring respective physical properties will be described.

[Measurement of Viscosity]

In the examples, a viscosity of each ink was measured using a falling ball automated microviscometer (“AMVn” manufactured by Anton Paar GmbH). In the measurement of the viscosity, a capillary having a diameter of 1.6 mm and a steel ball having a diameter of 1.5 mm and a specific gravity of 7.63 were used, and a falling angle was set to 70 degrees with a temperature set to 25° C. After the measurement, the viscosity of the ink was calculated using dedicated software for “AMVn” manufactured by Anton Paar GmbH.

[Measurement of Surface Tension]

A surface tension of each ink was measured using “AUTOMATED SURFACE TENSIOMETER DY-300” manufactured by Kyowa Interface Science, Inc. by the Wilhelmy method (plate method). In the measurement, the temperature was set to 25° C.

[Measurement of Volume Average Particle Diameter (MV) and Polydispersity Index]

In the examples, a volume average particle diameter (MV) and a polydispersity index of particles were measured using a dynamic light scattering particle size distribution analyzer (“ZETA SIZER (registered Japanese trademark) NANO ZS” manufactured by Symex Corporation). Specifically, a measurement target was diluted with ion exchanged water to be adjusted to a concentration suitable for the measurement (dilution ratio: at least 1000 times and no greater than 5000 times). In regard to the thus diluted solution, the volume average particle diameter (MV) and the polydispersity index were obtained using the dynamic light scattering particle size distribution analyzer based on a method described in ISO 13321:1996 (Particle size analysis-Photon correlation spectroscopy).

<Preparation of Ink>

Principal materials used in preparation of inks were as follows:
Pigment dispersion: A dispersion containing water, a pigment (Pigment Blue 15:3), and coating resin particles (acrylic resin) (concentration of pigment: 15% by mass), “EMACOL (registered Japanese trademark) SF AD2080F” manufactured by Sanyo Color Works, Ltd.
Aqueous urethane dispersion: A dispersion containing water and urethane resin particles (concentration of urethan resin particles: 30% by mass), “UPUD-ST-053D” manufactured by Ube Industries, Ltd.
Acrylic acid-based emulsion: A dispersion containing water and acrylic resin particles (concentration of acrylic resin particles: 50% by mass), “TOCRYL (registered Japanese trademark) X-4402” manufactured by Toyochem Co., Ltd.
Hydrophilic silica particle dispersion A: A dispersion containing water and hydrophilic fumed silica particles (concentration of hydrophilic fumed silica particles: 20% by mass), “W7530” manufactured by Nippon Aerosil Co., Ltd., volume average particle diameter (MV): 120 nm, polydispersity index: 0.12
Hydrophobic silica particle dispersion: A dispersion containing water and hydrophobic fumed silica particles, “W-8520N” manufactured by Nippon Aerosil Co., Ltd., volume average particle diameter (MV): 130 nm, polydispersity index: 0.15
“OLFINE (registered Japanese trademark) E1010” manufactured by Nissin Chemical Industry Co., Ltd.: a surfactant containing an ethylene oxide adduct of acetylenediol
High-boiling point organic solvent: glycerin (special grade reagent manufactured by Kanto Chemical Co., Inc., boiling point: 290° C.

(Preparation of Hydrophilic Silica Particle Dispersion B)

A diluted solution was obtained by adding 60.0 g of ion exchanged water to 20.0 g of a hydrophilic colloidal silica particle dispersion containing water and hydrophilic colloidal silica particles (“SANSIL (registered Japanese trademark) SS-01” manufactured by Tokuyama Corporation), and preliminarily stirring the resultant using a stirrer. Subsequently, a 1 M sodium hydroxide aqueous solution was added to the diluted solution to adjust pH to 10. Thereafter, the diluted solution having been adjusted in pH was subjected to a high pressure dispersion treatment (pressure condition: 50 MPa) using a high pressure dispersion apparatus (“NANOVATER” (registered Japanese trademark) C-ES” manufactured by Yoshida Kikai Co., Ltd.). The diluted solution having been subjected to the high pressure dispersion treatment was adjusted in pH to 10 again by adding a 1 M sodium hydroxide aqueous solution, and the resultant was diluted by further adding ion exchanged water to a total amount of 100.0 g, and thus, a hydrophilic silica particle dispersion B was obtained. The thus obtained hydrophilic silica particle dispersion B had a solid concentration of 20% by mass, a volume average particle diameter (MV) of 100 nm, and a polydispersity index of 0.25.

### Example 1

The above-described pigment dispersion (concentration: 15% by mass) in an amount of 20.0 g was mixed with 14.0 g of the aqueous urethane dispersion (concentration: 30% by mass) used as the binder resin particle dispersion. To the thus obtained mixed liquid, 21.0 g of the hydrophilic silica particle dispersion A (concentration: 20% by mass) and 0.5 g of the surfactant (“OLFINE (registered Japanese trademark) E1010” manufactured by Nissin Chemical Industry Co., Ltd.) were added, and the resultant was diluted with ion exchanged water to a total amount of 60.0 g. Thus, an ink (color: cyan) of Example 1 was obtained. The ink of Example 1 had a viscosity at 25° C. of 5 mPa·s, and a surface tension at 25° C. of 30 mN/m.

Inks of Examples 2 to 6 and Comparative Examples 1 to 8 were prepared each in an amount of 60.0 g in the same manner as in the preparation of the ink of Example 1 except for the following. The composition, the viscosity and the surface tension at 25° C. of each ink are shown in Table 1 below. In Table 1 below, “% by mass” regarding the binder resin particles and the inorganic particles refers to a concentration of an active ingredient (solid content).

### Example 2

In the preparation of the ink of Example 2, the amount of the pigment dispersion was changed to 12.0 g, and the amount of the hydrophilic silica particle dispersion A was changed to 30.0 g.

### Example 3

In the preparation of the ink of Example 3, the amount of the aqueous urethane dispersion was changed to 24.0 g, and the amount of the hydrophilic silica particle dispersion A was changed to 9.0 g.

### Example 4

In the preparation of the ink of Example 4, the hydrophilic silica particle dispersion A was not used, but 24.0 g of the hydrophilic silica particle dispersion B (concentration: 20% by mass) was used instead.

### Example 5

In the preparation of the ink of Example 5, the aqueous urethane dispersion was not used as the binder resin particle dispersion, but 8.4 g of the acrylic acid-based emulsion (concentration: 50% by mass) was used instead.

### Example 6

In the preparation of the ink of Example 6, 1.8 g of glycerin that is a high-boiling point organic solvent was added.

### Comparative Example 1

In the preparation of the ink of Comparative Example 1, the hydrophilic silica particle dispersion A was not used, but 21 g of the hydrophobic silica particle dispersion (concentration: 20% by mass) was used instead.

### Comparative Example 2

In the preparation of the ink of Comparative Example 2, the amount of the pigment dispersion was changed to 12.0 g, the amount of the hydrophilic silica particle dispersion A was changed to 45.0 g, and the binder resin particle dispersion was not used.

### Comparative Example 3

In the preparation of the ink of Comparative Example 3, the amount of the pigment dispersion was changed to 28.0 g, the amount of the hydrophilic silica particle dispersion A was changed to 30.0 g, and the binder resin particle dispersion was not used.

### Comparative Example 4

In the preparation of the ink of Comparative Example 4, the amount of the aqueous urethane dispersion was changed to 6.0 g, and the amount of the hydrophilic silica particle dispersion A was changed to 30.0 g.

### Comparative Example 5

In the preparation of the ink of Comparative Example 5, 3.0 g of glycerin that is a high-boiling point organic solvent was added.

### Comparative Example 6

In the preparation of the ink of Comparative Example 6, the hydrophilic silica particle dispersion A was not used, and 3.0 g of glycerin that is a high-boiling point organic solvent was added.

### Comparative Example 7

In the preparation of the ink of Comparative Example 7, the hydrophilic silica particle dispersion A was not used.

### Comparative Example 8

In the preparation of the ink of Comparative Example 8, the amount of the pigment dispersion was changed to 10.0 g, the amount of the aqueous urethane dispersion was changed to 10.0 g, and the amount of the hydrophilic silica particle dispersion A was changed to 39.0 g.

Note that each of the inks of Examples 1 to 6 and Comparative Examples 1 to 8 contained a high-boiling point organic solvent derived from the pigment dispersion, the binder resin particle dispersion or the like, but the content rate thereof was merely a trace amount (less than 0.1% by mass).

TABLE 1

| | | | | | | High-boiling Point | | | |
|---|---|---|---|---|---|---|---|---|---|
| | Pigment | Binder Resin Particles | | Inorganic Particles | | Organic Solvent | | | Surface |
| | [% | | Mass | | Mass | | Mass | Viscosity | Tension |
| | by mass] | Type | [% by mass] | Type | [% by mass] | Type | [% by mass] | [mPa · s] | [mN/m] |
| Example 1 | 5.0 | Urethane Resin | 7.0 | Hydrophilic Silica Particles A | 7.0 | — | — | 5 | 30 |
| Example 2 | 3.0 | Urethane Resin | 7.0 | Hydrophilic Silica Particles A | 10.0 | — | — | 6 | 28 |
| Example 3 | 5.0 | Urethane Resin | 12.0 | Hydrophilic Silica Particles A | 3.0 | — | — | 6 | 32 |
| Example 4 | 5.0 | Urethane Resin | 7.0 | Hydrophilic Silica Particles B | 8.0 | — | — | 5 | 29 |
| Example 5 | 5.0 | Acrylic Resin | 7.0 | Hydrophilic Silica Particles A | 7.0 | — | — | 5 | 30 |
| Example 6 | 5.0 | Urethane Resin | 7.0 | Hydrophilic Silica Particles A | 7.0 | Glycerin | 3.0 | 6 | 31 |
| Comparative | 5.0 | Urethane Resin | 7.0 | Hydrophobic Silica Particles | 7.0 | — | — | 5 | 32 |
| Example 1 | | | | | | | | | |
| Comparative | 3.0 | — | — | Hydrophilic Silica Particles A | 15.0 | — | — | 5 | 27 |
| Example 2 | | | | | | | | | |
| Comparative | 7.0 | — | — | Hydrophilic Silica Particles A | 10.0 | — | — | 5 | 29 |
| Example 3 | | | | | | | | | |
| Comparative | 5.0 | Urethane Resin | 3.0 | Hydrophilic Silica Particles A | 10.0 | — | — | 5 | 28 |
| Example 4 | | | | | | | | | |
| Comparative | 5.0 | Urethane Resin | 7.0 | Hydrophilic Silica Particles A | 7.0 | Glycerin | 5.0 | 7 | 30 |
| Example 5 | | | | | | | | | |
| Comparative | 5.0 | Urethane Resin | 7.0 | — | — | Glycerin | 5.0 | 5 | 33 |
| Example 6 | | | | | | | | | |
| Comparative | 5.0 | Urethane Resin | 7.0 | — | — | — | — | 3 | 34 |
| Example 7 | | | | | | | | | |
| Comparative | 2.5 | Urethane Resin | 5.0 | Hydrophilic Silica Particles A | 13.0 | — | — | 6 | 27 |
| Example 8 | | | | | | | | | |

<Evaluation>

Each of the inks of Examples 1 to 7 and Comparative Examples 1 to 8 were evaluated by the following methods for durability (abrasion resistance and adhesion to a recording medium) of an image formed therewith, ejection stability, and storage stability. The evaluation results are shown in Table 2 below. It is noted that an image to be used for the evaluation of durability could not be formed with the ink of Comparative Example 1 because a nozzle was clogged immediately after starting printing. Therefore, the ink of Comparative Example 1 was not evaluated for durability of an image formed therewith.

(Evaluation Apparatus)

Each ink to be evaluated was loaded in an ink chamber of a dedicated cartridge of an inkjet printer (“PX-045a” manufactured by Seiko Epson Corporation). The dedicated cartridge was attached to the inkjet printer. The resultant inkjet printer was used as an evaluation apparatus.

[Adhesion]

The aforementioned evaluation apparatus was used to form a solid image (coverage rate: 100%) on an OHP film for inkjet recording (manufactured by 3M Japan Co., Ltd.). The OHP film for inkjet recording having the solid image formed thereon was heated at 120° C. for 30 seconds to dry the image. The resultant OHP film for inkjet recording was used as a sample for performing a cross-cut test (cross-cut method). Specifically, grid-shaped (tessellated) six cuts extending at an interval of 2 mm in each of the vertical and lateral directions were formed to form twenty-five square grids each having a side of 2 mm on the image formed on the sample. An adhesive tape (“CELLOTAPE (registered Japanese trademark) CT-24” manufactured by Nichiban Co., Ltd.) was caused to adhere onto the image having the cuts formed thereon, and the adhesive tape was peeled off at a peeling angle of about 60 degrees. At this point, the adhesive tape was peeled at such a speed that time from the start of the peeling to the end of the peeling was about 1 second. After peeling the adhesive tape off, a peeled surface on the sample was observed to classify the extent of the peeling into class 0 to class 5 in accordance with Japanese Industrial Standards (JIS) K5600-5-6: 1999. According to this classification, class 0 means that the peeling is inhibited the most, and the extent of peeling is larger as the numerical value of the class is larger. The adhesion to the recording medium of the image formed with the ink was evaluated as good (A) when it was classified into class 0 or class 1, and was evaluated as poor (B) when it was classified into classes 2 to 5.

[Abrasion Resistance]

A sample (an OHP film for inkjet recording having a solid image formed thereon) was prepared in the same manner as in the evaluation for the adhesion. The sample was subjected to evaluation for abrasion resistance in accordance with Japanese Industrial Standards (JIS) L0849: 2013. Specifically, the sample cut into the shape of a strip of approximately 220 mm×30 mm was set on a color fastness rubbing tester (type II) (“COLOR FASTNESS RUBBING TESTER (Type II)” manufactured by Yasuda Seiki Seisakusho Ltd.). White cotton cloth for evaluation was pressed under a load of 200 g against the image formed on the sample in the strip shape thus set, and the white cotton cloth for evaluation was reciprocated 100 times with the load maintained. Thereafter, the extent of a stain thus caused on the white cotton cloth for evaluation was classified using a grey scale for assessing staining according to Japanese Industrial Standards (JIS) L0805: 2005. In the classification, the extent of the stain was classified into nine steps of a rating of 1, a rating of 1-2, a rating of 2, a rating of 2-3, a rating of 3, a rating of 3-4, a rating of 4, a rating of 4-5, and a rating of 5. In this classification, a rating with a smaller numerical value means a larger extent of the stain. The abrasion resistance of the image formed with the ink was evaluated as good (A) when the extent of the stain was rated as 4, 4-5, or 5, and was evaluated as poor (B) in the other cases.

[Ejection Stability]

The above-described evaluation apparatus was used to form a solid image (coverage rate: 100%) on successive 30 pieces of an OHP film for inkjet recording (manufactured by 3M Japan Co., Ltd.). Thereafter, the evaluation apparatus was used to print a nozzle check pattern on another sheet of the OHP film for inkjet recording. Based on the thus formed nozzle check pattern, the number of nozzles causing nozzle missing (the number of missed nozzles) out of the total number (128) of the nozzles was calculated. A smaller number of missed nozzles means that the ink has better ejection stability. Ejection stability of the ink was evaluated as good (A) when the number of missed nozzles was less than 10, and was evaluated as poor (B) when the number of missed nozzles was at least 10.

[Storage Stability]

Each ink was diluted 10,000-fold with ion exchanged water. The thus obtained 10,000-fold diluted ink was measured for absorbance at a measurement wavelength of 500 nm using an ultraviolet and visible spectrophotometer (“U-3010” manufactured by Hitachi High-Tech Science Corporation). The thus measured absorbance was defined as “absorbance A”.

Next, each ink was put in a sealed container to be allowed to stand still under an environment of a temperature of 50° C. for 1 week. Thereafter, the ink held in the sealed container was lightly stirred by manually shaking the sealed container. The thus stirred ink was diluted 10 fold with ion exchanged water. Then, 10 mL of the ink (diluted 10 fold) was put in a measuring cylinder (capacity: 10 mL) to be allowed to stand still under an environment of a temperature of 25° C. and a relative humidity of 50% for 1 week. After the standing still, 2 mL of a supernatant was collected from the ink (diluted 10 fold) held in the measuring cylinder, and the collected supernatant was diluted 1,000 fold with ion exchanged water. The thus obtained 1,000-fold diluted supernatant was measured for absorbance at a measuring wavelength of 500 nm using the ultraviolet and visible spectrophotometer. The thus measured absorbance was defined as “absorbance B”. Based on the absorbance A and the absorbance B, a storage stability [%] of the ink was calculated in accordance with the following expression. The storage stability of the ink was determined to be better as the storage stability is closer to 100%, and the ink was evaluated as good (A) when the storage stability was at least 90%, and was evaluated as poor (B) when the storage stability was lower than 90%.

Storage Stability [%]=100×absorbance B/absorbance A

TABLE 2

| | | | | | Ejection Stability | | Storage Stability | |
|---|---|---|---|---|---|---|---|---|
| | | | | | Number of | | Storage | |
| | Adhesion | | Abrasion Resistance | | Missed Nozzles | | Stability | |
| | Type | Evaluation | Rating | Evaluation | [Number] | Evaluation | [%] | Evaluation |
| Example 1 | 1 | A | 4-5 | A | 1 | A | 95 | A |
| Example 2 | 1 | A | 5 | A | 3 | A | 92 | A |
| Example 3 | 0 | A | 4 | A | 8 | A | 95 | A |
| Example 4 | 1 | A | 4-5 | A | 4 | A | 93 | A |
| Example 5 | 1 | A | 4 | A | 2 | A | 95 | A |
| Example 6 | 1 | A | 4 | A | 0 | A | 90 | A |
| Comparative | — | — | — | — | 10< | B | 75 | B |
| Example 1 | | | | | | | | |
| Comparative | 3 | B | 2 | B | 1 | A | 90 | A |
| Example 2 | | | | | | | | |
| Comparative | 3 | B | 2 | B | 3 | A | 92 | A |
| Example 3 | | | | | | | | |
| Comparative | 2 | B | 3 | B | 2 | A | 95 | A |
| Example 4 | | | | | | | | |
| Comparative | 2 | B | 3-4 | B | 10 | B | 90 | A |
| Example 5 | | | | | | | | |
| Comparative | 2 | B | 2 | B | 0 | A | 92 | A |
| Example 6 | | | | | | | | |
| Comparative | 0 | A | 3 | B | 3 | A | 96 | A |
| Example 7 | | | | | | | | |
| Comparative | 2 | B | 4 | A | 10< | B | 85 | B |
| Example 8 | | | | | | | | |

Each of the inks of Examples 1 to 6 contained the aqueous medium, the pigment, the binder resin particles, and the hydrophilic inorganic particles. The content rate of the binder resin particles was at least 4.0% by mass and no greater than 20.0% by mass. The content rate of the hydrophilic inorganic particles was at least 1.0% by mass and no greater than 12.0% by mass. Each of the inks of Examples 1 to 6 did not contain an organic solvent having a boiling point of at least 150° C., or contained an organic solvent having a boiling point of at least 150° C. in a content rate over 0.0% by mass and no greater than 4.0% by mass. As a result, as shown in Table 2, the inks of Examples 1 to 6 were excellent in durability (abrasion resistance and adhesion to a recording medium) of the image formed therewith, and ejection stability. Besides, the inks of Examples 1 to 6 were excellent also in storage stability.

By contrast, the inks of Comparative Examples 1 to 8 did not satisfy the above-described structural requirements. Specifically, the ink of Comparative Example 1 did not contain the hydrophilic inorganic particles but contained the hydrophobic silica particles instead. As a result, the ink of Comparative Example 1 was poor in ejection stability and storage stability. It is determined that ejection stability and storage stability were degraded because the hydrophobic silica particles agglomerated in the ink of Comparative Example 1.

The inks of Comparative Examples 2 and 3 did not contain the binder resin particles. Further, in the ink of Comparative Example 4, the content rate of the binder resin particles was less than 4.0% by mass. Furthermore, in the ink of Comparative Example 2, the content rate of the hydrophilic inorganic particles was over 12.0% by mass. As a result, each ink of Comparative Examples 2 to 4 were poor in abrasion resistance and adhesion to the recording medium of the image formed therewith. It is determined that the pigment cannot be sufficiently fixed on the recording medium because the image formed with the ink of any of Comparative Examples 2 to 4 contained no or merely a small amount of the binder resin particles.

In the ink of Comparative Example 5, the content rate of the organic solvent having a boiling point of at least 150° C. was over 4.0% by mass. As a result, the ink of Comparative Example 5 was poor in abrasion resistance and adhesion to the recording medium of the image formed therewith. It is determined that durability of an ink coating film was insufficient because the organic solvent having a boiling point of at least 150° C. easily remained in the image formed with the ink of Comparative Example 5.

The ink of Comparative Example 6 did not contain the hydrophilic inorganic particles, and the content rate therein of the organic solvent having a boiling point of at least 150° C. was over 4.0% by mass. As a result, the ink of Comparative Example 6 was poor in abrasion resistance and adhesion to the recording medium of the image formed therewith. It is determined that durability of an ink coating film was insufficient because the organic solvent having a boiling point of at least 150° C. easily remained in the image formed with the ink of Comparative Example 6.

The ink of Comparative Example 7 did not contain the hydrophilic inorganic particles. As a result, the ink of Comparative Example 7 was poor in abrasion resistance of the image formed therewith. It is determined that abrasion resistance was degraded because the ink of Comparative Example 7 had such a low viscosity that an ejection amount was varied, and hence the thickness of an ink coating film was uneven.

In the ink of Comparative Example 8, the content rate of the hydrophilic inorganic particles was over 12.0% by mass. As a result, the ink of Comparative Example 8 was poor in ejection stability and storage stability. It is determined that ejection stability and storage stability were degraded because the ink of Comparative Example 8 contained such a large amount of the hydrophilic inorganic particles that the hydrophilic inorganic particles easily agglomerated.

From the above, it is determined that the inkjet recording ink according to the present disclosure can be used for forming an image with excellent durability, and is excellent in the ejection stability.

What is claimed is:

1. An inkjet recording ink comprising an aqueous medium, a pigment, binder resin particles, and hydrophilic inorganic particles, wherein
a content rate of the binder resin particles is at least 4.0% by mass and no greater than 20.0% by mass,
a content rate of the hydrophilic inorganic particles is at least 1.0% by mass and no greater than 12.0% by mass, and
the inkjet recording ink does not contain an organic solvent having a boiling point of at least 150° C., or contains an organic solvent having a boiling point of at least 150° C. in a content rate over 0.0% by mass and no greater than 4.0% by mass.

2. The inkjet recording ink according to claim 1, wherein
the hydrophilic inorganic particles are hydrophilic silica particles.

3. The inkjet recording ink according to claim 1, wherein
a content rate of the pigment is at least 1.0% by mass and no greater than 8.0% by mass.

4. The inkjet recording ink according to claim 1, wherein
the binder resin particles contain a urethane resin or a (meth)acrylic resin.
